(19) United States
(12) Patent Application Publication
(10) Pub. No.: US 2014/0007149 A1
(43) Pub. Date: Jan. 2, 2014

(54) SYSTEM, APPARATUS AND METHOD FOR MULTIMEDIA EVALUATION

(71) Applicants: QIAN HUANG, NEW TAIPEI CITY (TW); YONG-NAN WANG, NEW TAIPEI CITY (TW)

(72) Inventors: QIAN HUANG, NEW TAIPEI CITY (TW); YONG-NAN WANG, NEW TAIPEI CITY (TW)

(73) Assignee: WISTRON CORP., NEW TAIPEI CITY (TW)

(21) Appl. No.: 13/616,193

(22) Filed: Sep. 14, 2012

(30) Foreign Application Priority Data
Jul. 2, 2012 (CN) 201210227794.6

(51) Int. Cl. H04N 21/24

(52) U.S. Cl. 725/12

(57) ABSTRACT

The present disclosure illustrates a multimedia evaluation system which includes a display unit and a multimedia evaluation apparatus. The display unit is used for playing a multimedia data. The multimedia evaluation apparatus is coupled to the display unit. The multimedia evaluation apparatus is used for capturing and recording a facial expression of a viewer when the viewer viewing the multimedia data. The multimedia evaluation apparatus generates a multimedia evaluation data according to the facial expression of the viewer. The multimedia evaluation data includes a plurality of emotional tags. Each emotional tag has an emotion symbol and a playback time in corresponding to the multimedia data. The multimedia evaluation apparatus further determines the type of the multimedia data according to the multimedia evaluation data. Thus, the multimedia evaluation system can determine the type of the multimedia data through analyzing true feeling of the viewer toward the multimedia data.

### BACKGROUND

1. Technical Field

The present disclosure relates to evaluation method in particular, to a system, an apparatus, and method for multimedia evaluation.

2. Description of Related Art

As internet and multimedia technology advance, the online video streaming industry has been widely known and used by public, further has become a mainstream industry among all the internet industries.

Online video streaming includes television programs, movies, personal uploaded videos, and etc., further the video type and whether the video is worth watching or not are generally determined by the content description and the associated comments. Accordingly, video viewers usually would choose a video to watch based on content descriptions and/or comments written by other viewers. However, for videos described only by plain words, it could sometimes be boring, plain, and unpersuasive. Moreover, not every video viewer would take time to leave hi/hers comment for the particular video which he/she has watched. In addition, most of video comments are based on video viewers' personal preference and thus may be subjective. As a result, video viewers are unable to obtain objective comments and select an appropriate video accordingly, thereby gradually lose interest in viewing the video.

At the same time, video providers may not accurately analyze and determine the true value of any video based on the comments from the general video viewers as well. Additionally, the video viewer in general can only select a specific video segment of a video through configuring the playback time, and the selected specific video segment may not even be the part that the video viewers want to view. Accordingly, video viewers often need to constantly adjust the playback time which not only wastes video viewer's time but also decreases the degree of viewing interest of the video viewers.

### SUMMARY

An exemplary embodiment of the present disclosure provides a multimedia evaluation system, and the system can analyze and determine the type of a multimedia data by the captured facial expression of a viewer when viewing the multimedia data. Thus, the type and the content associated with the multimedia data can be precisely and effectively determined by the true feeling of the viewer.

An exemplary embodiment of the present disclosure provides a multimedia evaluation apparatus which can be applied to the aforementioned multimedia evaluation system. The multimedia evaluation apparatus is used for capturing and recording the facial expression of a viewer when viewing the multimedia data. Moreover, the multimedia evaluation apparatus is used to identify and analyze the facial expression of the viewer and then determine the type and the content associated with the multimedia data according to the facial expression of the viewer.

An exemplary embodiment of the present disclosure provides a multimedia evaluation method, which can capture the facial expression of a viewer when viewing a multimedia data by using a multimedia evaluation apparatus and analyze the facial expression of the viewer to identify the facial expression. The multimedia evaluation apparatus further determine the type of the multimedia data according to the analyzation result of the facial expression.

According to one exemplary embodiment of the present disclosure, a multimedia evaluation system is provided. The multimedia evaluation system includes a display unit and a multimedia evaluation apparatus. The display unit can be used for playing a multimedia data. The multimedia evaluation apparatus is coupled to the display unit. The multimedia evaluation apparatus can be used for capturing and recording the facial expression of a viewer when viewing multimedia data so as to generate a multimedia evaluation data according to the facial expression of the viewer. The multimedia evaluation data includes a plurality of emotional tags, wherein each emotional tag has an emotional symbol and playback time in corresponding to the multimedia data. The multimedia evaluation apparatus further determines the type of the multimedia data based on the multimedia evaluation data.

According to one exemplary embodiment of the present disclosure, the multimedia evaluation apparatus divides the multimedia data into segments according to the emotional tags and integrates the segments into a multimedia player for viewers to select.

According to one exemplary embodiment of the present disclosure, a multimedia evaluation apparatus is provided. The multimedia evaluation apparatus includes an image capturing unit, a processing unit, and a storage unit. The image capturing unit is for capturing and recording the facial expression of viewers when viewing the multimedia so as to correspondingly output an image of the facial expression. The processing unit is coupled to the image capturing unit and is for receiving and analyzing the image of the facial expression so as to generate a multimedia evaluation data. The multimedia evaluation data includes a plurality of emotional tags, wherein each of the emotional tags includes an emotional symbol and a playback time in corresponding to the multimedia data. The storage unit is coupled to the processing unit and is for storing the image of the facial expression and the multimedia evaluation data. The processing unit can determine the type of a multimedia data according to the multimedia evaluation data.

According to one exemplary embodiment of the present disclosure, the types of the emotional symbol include a neutral emotional symbol, a joy emotional symbol a happy emotional symbol, a sadness emotional symbol, a disgust emotional symbol, and a terrifying emotional symbol.

According to one exemplary embodiment of the present disclosure, the processing unit determines the emotional symbols of the emotional tags through extracting a plurality of facial expression parameters in the image of the facial expression.

According to one exemplary embodiment of the present disclosure, the multimedia evaluation apparatus further includes a communication unit. The communication unit is coupled to the processing unit. The communication unit is for transmitting the multimedia data, the image of the facial expression, and the multimedia evaluation data to a server through an internet.

An exemplary embodiment of the present disclosure provides a multimedia evaluation method. The multimedia evaluation method includes the following steps. Firstly, a multimedia data is played. Secondly, when viewing the multimedia data, the facial expression of the viewer is captured and recorded. Thirdly, a multimedia evaluation data is then generated according to the facial expression of the viewer. The multimedia evaluation data includes a plurality of emotional tags wherein each emotional tag has an emotional symbol and a playback time in corresponding to the multimedia data. Subsequently, the type of the multimedia is determined according to the multimedia evaluation data.

According to one exemplary embodiment of the present disclosure, the step of determining the type of the multimedia data according to the multimedia evaluation data includes analyzing the multimedia evaluation data and statistically computing the quantity associated with each type of the emotional symbols; determining the type of the multimedia data based on the analyzation and computation result associated with each type of the emotional symbols.

To sum up, an exemplary embodiment of the present disclosure provides a system, an apparatus, and method for multimedia evaluation. The disclosed system, apparatus, and method for multimedia evaluation can determine the type of a multimedia data through capturing and analyzing the facial expression of a viewer when viewing a multimedia data, such as a video or a presentation slide. Thus, the disclosed system, apparatus, and method for multimedia evaluation may precisely and effectively determine the type and the content of the multimedia data by the true feelings of the viewer instead of plain words and subjective comments. The degree of viewing interest of the viewers may thereby be increased.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a multimedia evaluation system provided in accordance to the first exemplary embodiment of the present disclosure.

FIG. 2 is a block diagram of a multimedia evaluation apparatus provided in accordance to the first exemplary embodiment of the present disclosure.

FIG. 3A-3E are schematic diagrams illustrating various facial expressions provided in accordance to the first exemplary embodiment of the present disclosure.

FIG. 4 is a diagram illustrating an evaluation functional configuration interface provided in accordance to the first exemplary embodiment of the present disclosure.

FIG. 5 is a schematic diagram illustrating an application of the emotional tag in a multimedia player provided in accordance to the first exemplary embodiment of the present disclosure.

FIG. 6 is a flowchart diagram illustrating a multimedia evaluation method provided in accordance to the second exemplary embodiment of the present disclosure.

FIG. 7 is a flowchart diagram illustrating a facial expression analyzation method provided in accordance to the second exemplary embodiment of the present disclosure.

FIG. 8 is a flowchart diagram illustrating a method for acquiring the multimedia evaluation data provided in accordance to the second exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### First Exemplary Embodiment

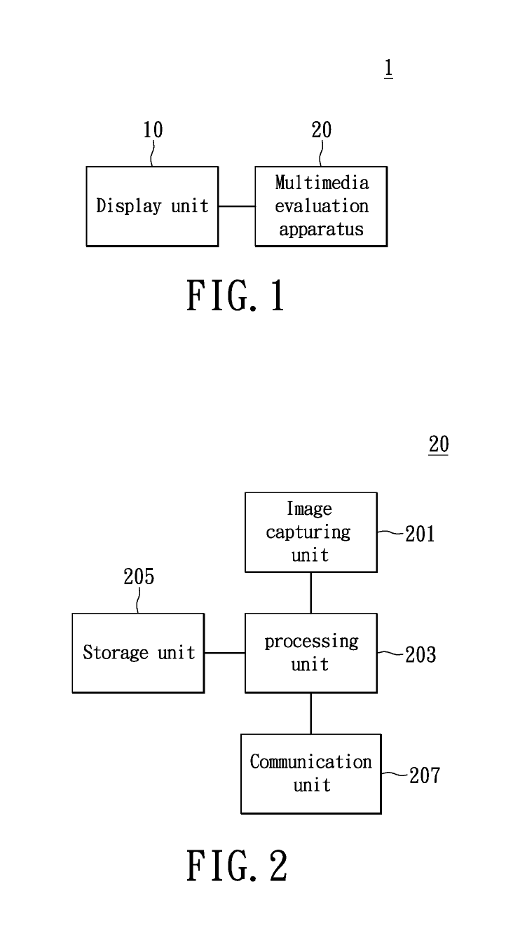

Please refer to FIG. 1 which shows a block diagram of a multimedia evaluation system provided in accordance to the first exemplary embodiment of the present disclosure. A multimedia evaluation system 1 can actively determine and analyze the type of a multimedia data based on the true feeling of a viewer toward the multimedia data. The multimedia evaluation system 1 includes a display unit 10 and a multimedia evaluation apparatus 20. The display unit 10 is coupled to the multimedia evaluation apparatus 20.

It is worth to note that the display unit 10 and the multimedia evaluation apparatus 20 can be integrated in an electric apparatus or separately disposed, however the instant embodiment is not limited thereto. The electric apparatus in the instant embodiment may be implemented by a television, a desktop, a laptop, a tablet, or a smart phone, however the instant embodiment in not limited to the example provided herein. In practice, the display unit 10 can be wired or wirelessly connected to the multimedia evaluation apparatus 20 for data transmission (e.g., the multimedia data transmission).

The display unit 10 is for playing a multimedia data to a viewer. The multimedia data in the instant embodiment may include but not limited to a video data (e.g., a movie or a television program), an image (e.g., a photo), or a paper. The display unit 10 may be a display equipment such as a cathode ray tube (CRT) display, a liquid crystal display (LCD), a plasma display panel, or a projection display.

The multimedia evaluation apparatus 20 is used for capturing and recording the facial expression of a viewer (e.g., happy expression, sadness expression, terrifying expression, surprising expression or anger expression) when viewing the multimedia data so as to generate a multimedia evaluation data based on the facial expression of the viewer. The multimedia evaluation apparatus 20 can determine the type of the multimedia data according to the multimedia evaluation data. Alternately, the multimedia evaluation apparatus 20 can determine the type of the multimedia data through identifying the facial expression of viewers as the viewer viewing the multimedia data. Additionally, the multimedia evaluation apparatus 20 can study the degree of preference associated with the viewer toward the multimedia data based on the multimedia evaluation data.

Simply speaking, the multimedia evaluation apparatus 20 can instantly capture and record the facial expression of the viewer when viewing the multimedia data. The multimedia evaluation apparatus 20 generates a multimedia evaluation data according to the facial expression of the viewer. In the instant embodiment, the multimedia evaluation data may include a plurality of emotional tags and each emotional tag has an emotional symbol and a playback time in corresponding to the multimedia data. The emotional symbol of each emotional tag corresponds to the facial expression of the viewer when viewing the multimedia data. The playback time associated with the multimedia data corresponds to the capture time of the facial expression of the viewer. The multimedia evaluation apparatus 20 may determine the type of the multimedia data based on the types and quantities of the emotional symbols in the emotional tags contained in the multimedia evaluation data.

The types of the emotional symbol may correspond to different facial expressions, including but not limited to the neutral emotional symbol in corresponding to the neutral facial expression, the joy emotional symbol in corresponding to the joy facial expression, the anger emotional symbol in corresponding to the anger facial expression, the terrifying emotional symbol in corresponding to the terrifying facial expression, the disgust emotional symbol in corresponding to the disgust facial expression, and the surprise emotional symbol in corresponding to the surprise facial expression.

Moreover, the multimedia evaluation apparatus 20 can also divide the multimedia data into segments according to the emotional tags and integrate the segmented multimedia data into a multimedia player for the viewer to select. To put it concretely, the viewer may select an appropriate emotional tag according to the emotional symbol so as to select the desired segment of a multimedia data to view. The viewer further can control the display unit 10 to display the corresponding multimedia data through configuring the multimedia evaluation apparatus 20.

It is worth to note that the multimedia evaluation apparatus 20 may be configured to automatically capture and record the facial expression of a viewer after every predetermined time interval (e.g., after every minute) to generate emotional tags, accordingly. The multimedia evaluation data is then generated according to the emotional tags to evaluate the multimedia data.

For instance, supposing the played multimedia data is a movie, and the multimedia evaluation apparatus 20 can automatically capture the facial expression of a viewer when viewing the movie according to the user-configuration to generate a multimedia evaluation data. The multimedia evaluation apparatus 20 further determines the type of the movie to be a comedy, an action film, or a thriller according to the multimedia evaluation data. Additionally, the multimedia evaluation apparatus 20 may determine the degree of preference and the degree of satisfaction of the viewer toward the played movie content according to the multimedia evaluation data. Thus, the multimedia evaluation apparatus 20 may thereby obtain the true evaluation associated with the movie according the multimedia evaluation data. Furthermore, the multimedia evaluation apparatus 20 can also divide the movie into segments according to the emotional tags for the viewer to select according to his/her viewing preference.

For another instance, supposing the played multimedia data takes form of a plurality of digital images. The multimedia evaluation apparatus 20 can capture the facial expression of a viewer while viewing each digital image to generate a corresponding multimedia evaluation data. The multimedia evaluation apparatus 20 can analyze the feeling of the viewer toward each digital image according the multimedia evaluation data. Or equivalently, a plurality of emotional tags contained in the multimedia evaluation data respectively correspond to each and every digital image. And the multimedia evaluation apparatus 20 can classify the digital images according to the emotional tags. So that the viewer may select a specific digital image to view using the generated emotional tags through the multimedia evaluation apparatus 20.

The structure of the multimedia evaluation apparatus 20 are described in detail below. Please refer to FIG. 2 which depicts a block diagram of the multimedia evaluation apparatus provided in accordance to the first embodiment of the present disclosure. The multimedia evaluation apparatus 20 includes an image capturing unit 201, a processing unit 203, a storage unit 205, and a communication unit 207. The image capturing unit 201, the storage unit 205, and the communication unit 207 are respectively coupled to the processing unit 203. The multimedia evaluation apparatus 20 can analyze the facial expression of a viewer captured by the image capturing unit 201 and determine the true feeling of the viewer toward a multimedia data through the processing unit 203.

Specifically, the image capturing unit 201 can be used to capture and record the instant facial expression of the viewer when viewing the multimedia data to correspondingly output an image of the facial expression. The image capturing unit 201 may also as previously described capture the facial expression of a viewer after every predetermined time interval. The image capturing unit 201 in the instant embodiment may be a web camera, a video recorder, or a digital camera, however, the instant embodiment is not limited thereto. The image capturing unit 201 can be further disposed at a position facing the viewer so as to capture facial expression of the viewer.

The processing unit 203 is the operation core of the multimedia evaluation apparatus 20. The processing unit 203 receives the image of the facial expression and analyzes accordingly so as to correspondingly generate a multimedia evaluation data. As aforementioned, the multimedia evaluation data includes a plurality of emotional tags, wherein each emotional tag has an emotional symbol and a playback time in corresponding to the multimedia data. The processing unit 203 can further perform computation operations to the multimedia evaluation data to statically analyze the type and compute the quantity associated with each type of the emotional symbols so as to determine the type of the multimedia data. The processing unit 203 may be implemented by a processing chip including but not limited to a central process unit (CPU), a microcontroller, or an embedded controller, however the instant embodiment is not limited to the example provided herein.

The storage unit 205 is for storing the image of the facial expression and the multimedia evaluation data for the processing unit 203 to access based on the processing needs. It is worth noting that the storage unit 203 in the instant embodiment may be implemented by a volatile or a non-volatile memory such as a flash memory, a read only memory, or a random access memory, however the instant embodiment is not limited to the example provided herein.

It is worth to note that the processing unit 203 further includes the communication unit 207 which can provide the multimedia evaluation apparatus 20 with network communication functionality. The network communication functionality may include linking to the internet, packet processing, and network domain management. The communication unit 207 may be realized with hardware or software structure that can implement the aforementioned network communication functionalities. The processing unit 203 of the multimedia evaluation apparatus 20 may drive the communication unit 207 to connect a server through an internet so as to perform the transmission of the multimedia data, the image of the facial expression, and the multimedia evaluation data.

In one implementation, the server may be a multimedia data analyzer and manager. The processing unit 203 may drive the communication unit 207 to transmit the multimedia data, the image of the facial expression, and the multimedia evaluation data to the server through the internet for the server to analyze the type of the multimedia data as well as the reaction of the viewer. In another implementation, the server may be a multimedia data provider. The server may transmit the multimedia data to the multimedia evaluation apparatus 20 through the internet for the viewer to view.

For example, the multimedia data may be provided on a video website. Hence, the processing unit 203 of the multimedia evaluation apparatus 20 can capture the facial expression of a viewer when viewing the multimedia data on the video website, and transmit the image of the facial expression to the server by the communication unit 207 to analyze. Alternatively, the processing unit 203 of the multimedia evaluation apparatus 20 may also directly transmit the analyzed multimedia evaluation data to the server to conduct further analysis. The server can thereby determine the reaction of the viewer toward the server-provided multimedia data as well as the type of the multimedia data according to either the image of the facial expression or the multimedia evaluation data.

Moreover, when the multimedia evaluation data is stored in the server, the viewer may then send a request to the server acquiring the multimedia evaluation data using the communication unit 207 of the multimedia evaluation apparatus 20 through the internet. The viewer may further through the communication unit 207 of the multimedia evaluation apparatus 20 request the server to perform multimedia data searching operation according to the multimedia evaluation data.

More specifically, the processing unit 203 may continuously or after every specific time interval drive the image capturing unit 201 to capture the facial expression of the viewer when view a multimedia data to correspondingly generate the image of the facial expression. The processing unit 203 can instantly store the images of the facial expression in the storage unit 205. The processing unit 203 at the same time conducts image processing analysis and facial feature extraction operations to identify the corresponding facial expressions. In other words, the processing unit 203 can through perform the image processing analysis and the facial feature extraction operations on the images of the facial expression to extract a plurality of facial expression parameters including but not limited to the relative distance, location, size, and shape associated with eye brows, eyes, a nose, a mouth, and a chin.

Particularly, the image processing analysis may include image processing method and facial feature extraction operation to identify the facial expressions of the viewer. The image processing method may include gray scale transformation, image filtering, image binarization, edge detection, feature extraction, image compression, and image segmentation. In practice one may select an appropriate image processing technique to be the image processing method for the processing unit 203 to use according to the image recognition requirement.

The facial feature extraction operation may include but not limited to neural network, Support Vector Machine, template matching, active appearance model, conditional random field, Hidden Markov Model (HMM) and geometrical modeling. Those skilled in the art shall be able to deuce the actual implementation and operation of facial feature extraction, thus further descriptions are thereby omitted.

In the instant embodiment, the processing unit 203 uses geometrical modeling to analyze the image of the facial expression. In particular, the processing unit 203 builds a plurality of predefined emotional statistical models according to different facial expressions, wherein each predefined emotional statistical model is described by a plurality of emotional statistical parameter. In other words, each of the predefined emotional statistical models relates to a facial expression.

In general, human facial expression can be classified into five states, i.e., a neutral state, a disgusting state, a happy state, a surprising state, and an angry sate. The facial expression of a human can randomly change the facial expression thereof from any one of the described states into another. Accordingly, the predefined emotional statistical model in the instant embodiment may be defined based on the five facial expression states. The predefined emotional statistical model may for example include a neutral emotional statistical model, a disgust emotional statistical model, a happy emotional statistical model, a surprise emotional statistical model, and an anger emotional statistical model.

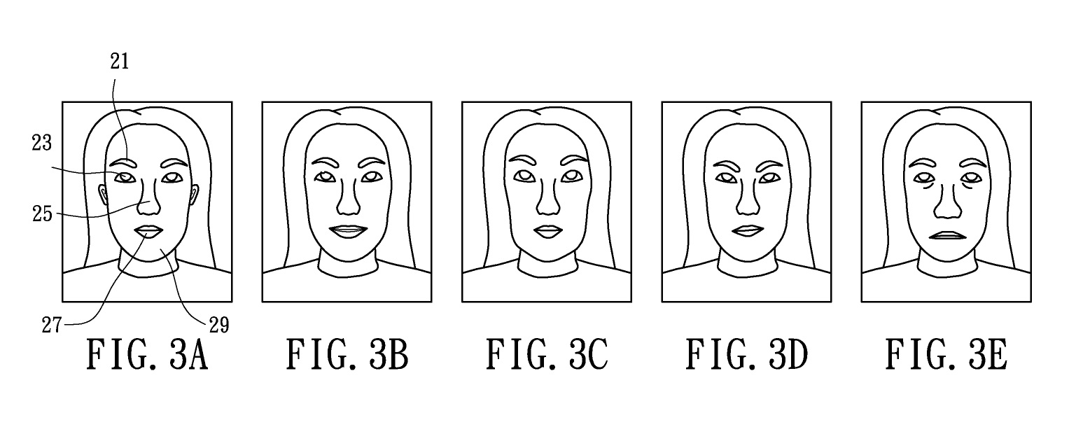

More specifically, please refer to FIG. 3A to FIG. 3E. FIG. 3A to FIG. 3E are schematic diagrams illustrating various facial expressions provided in accordance to the first exemplary embodiment of the present disclosure.

FIG. 3A represents a facial image with neutral facial expression. The processing unit 203 can build the neutral emotional statistical model by analyzing the emotional statistical parameters associated with the neutral facial expression. The emotional statistical parameters may include the relative distance among eye brows 21, eyes 23, a nose 25, a mouth 27, and a chin 29, the relative location of eye brows 21, eyes 23, the nose 25, the mouth 27, and the chin 29 as well as size and shape of eye brows 21, eyes 23, the nose 25, the mouth 27, and the chin 29.

Similarly, FIG. 3B represents a facial image with happy facial expression. The processing unit 203 can build the happy emotional statistical model by analyzing the emotional statistical parameters associated with the happy facial expression. FIG. 3C represents a facial image with surprise facial expression. The processing unit 203 can build the surprise emotional statistical model by analyzing the emotional statistical parameters associated with the surprise facial expression. FIG. 3D represents a facial image with anger facial expression. The processing unit 203 can build the anger emotional statistical model by analyzing the emotional statistical parameters associated with the anger facial expression. FIG. 3E represents a facial image with disgust facial expression. The processing unit 203 can build the disgust emotional statistical model by analyzing the emotional statistical parameters associated with the disgust facial expression. In other words, the emotional statistical parameters in corresponding to each predefined emotional statistical model are quantitatively described, wherein the emotional statistical parameters include the predefined relative distance, the predefined relative location, predefined size, and predefined shape associated with eye brows, eyes, the nose, the mouth, and the chin.

Furthermore, each predefined emotional statistical model has at least one corresponding emotional symbol. The configuration of emotional symbol can be determined through comparing the facial expression parameters with a plurality of predefined emotional statistical parameters associated with a plurality of predefined emotional statistical models. Accordingly, actual reaction and true feeling of the viewer as the viewer viewing the multimedia data can be described by the emotional symbols.

The processing unit 203 can compare the facial expression parameters with a plurality of predefined emotional statistical parameters associated with a plurality of predefined emotional statistical models so as to identify the image of facial expression. Or equivalently, the processing unit 203 can determine the predefined emotional statistical model in corresponding to the facial expression of the image of the facial expression through comparing the facial expression parameters with a plurality of predefined emotional statistical parameters associated with a plurality of predefined emotional statistical models Subsequently, the processing unit 203 can determine the emotional symbol in corresponding to the image of the facial expression based on the difference between the facial expression parameters and the plurality of predefined emotional statistical parameters of the selected predefined emotional statistical model.

The processing unit 203 can combine an emotional symbol and a playback time in corresponding to the multimedia data into an emotional tag. The processing unit 203 may execute the aforementioned image capturing, image processing and image analyzation operations until the multimedia data has finished playing so as to generate a multimedia evaluation data in corresponding to the multimedia data. The multimedia evaluation data associated with a multimedia data may have a plurality of emotional tags. The processing unit 203 may further perform arithmetic operations and analyzation to the emotional tags of the multimedia evaluation data.

To put it concretely, by statistically analyzing the types of the emotional tags and the quantity associated with each type of emotional tags, the type of multimedia data may be defined. In one embodiment of defining the multimedia data, the processing unit 203 may compute the total amount of the emotional tags, and divide the total by the overall recording time, e.g., the total playback time of the multimedia data, so as to obtain the facial expression changing frequency of the viewer. The processing unit 203 can further describe the content of a multimedia based on the facial expression changing frequency of the viewer. In addition, the processing unit 203 can determine the type of the multimedia data through comparing and analyze the formation time of each emotional tag, the types of the emotional tags, as well as the quantity associated with each type of the emotional tags.

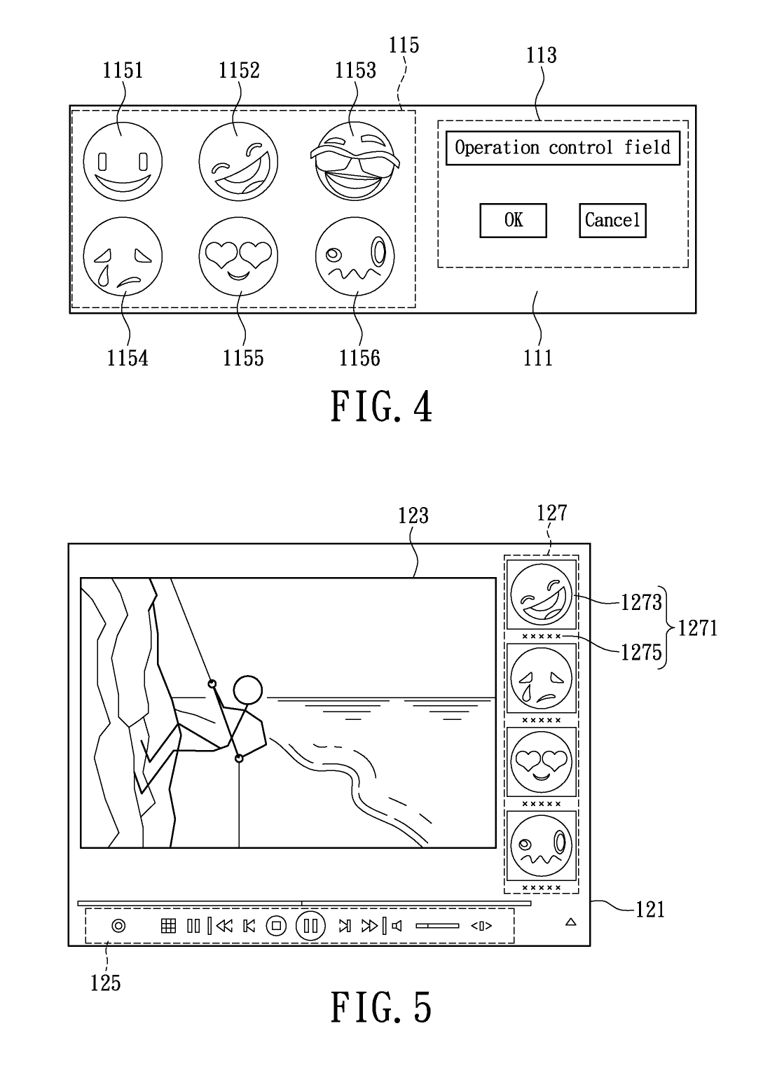

The operation of the multimedia evaluation apparatus 20 can be further explained by an actual application described follow. Please refer to FIG. 4 which shows a diagram illustrating an evaluation functional configuration interface provided in accordance to the first exemplary embodiment of the present disclosure. The processing unit 203 of the multimedia evaluation apparatus 20 can generate an evaluation functionality configuration interface 111 as shown in FIG. 4 and display using the display unit 10 of FIG. 1. The viewer can choose whether or not to turn on the facial expression evaluation function through configuring an operation control field 113 provided on the evaluation functionality configuration interface 111. When the viewer selects the button of “cancel”, the processing unit 203 instantly terminates the operation of the image capturing unit 201. On the other hand, when the viewer selects the button of “ok”, the processing unit 203 drives the image capturing unit 201 to capture the facial expression, conducts analysis thereto, and record the playback time in corresponding to the multimedia data. The processing unit 203 selects the corresponding emotional symbols e.g., a happy emotional symbol 1151, a laughing emotional symbol 1152, an exciting symbol 1153, a sadness emotional symbol 1154, a touching emotional symbol 1155, and a disgust emotional symbol 1156 from an emotional symbol selection field 115 according to the comparison result of the image of the facial expression of the viewer. The processing unit 203 combines the selected emotional symbol and the playback time in corresponding to the multimedia data into an emotional tag. The processing unit 203 can further combine a plurality of emotional tags into a multimedia evaluation data.

The processing unit 203 may further divide the multimedia data into segments according to the emotional tags, and then integrate the segmented multimedia data into a multimedia player 121 for the viewer to select. Please refer to FIG. 5 which shows a schematic diagram illustrating an application of the emotional tag in a multimedia player in the first exemplary embodiment of the present disclosure. As shown in FIG. 5, the multimedia player 121 includes a video playing area 123, a playback control bar 125, and an emotional tag display panel 127. The video playing area 123 is used for playing the multimedia data e.g., move or television program. The playback control bar 125 is used for controlling the playback operations. The emotional tag display panel 127 is for displaying a plurality of emotional tags 1271 for viewers to select so as to view the corresponding segment of the multimedia data, wherein each emotional tag 1271 includes an emotional symbol 1273 and a playback time 1275 in corresponding to the multimedia data.

Incidentally, even though the instant embodiment utilize the captured fiscal expression of the viewer to evaluate the multimedia data however the multimedia evaluation technique disclosed by the present disclosure may be applied in other fields such as market research for products, film production, or psychological assessment. For instance, before releasing a movie or a product, the producer of the movie or manufacturer of the product may obtain a general idea of the reaction of viewers or users toward the movie or the specific product by using the multimedia evaluation apparatus. So that the market and value associated with the movie or the product can be determined based on the true feeling of the viewers or the users. Consequently, based on the above explanation, those skilled in the art should be able to infer the actual implementation and operation of the described evaluation applications, and further descriptions are omitted.

It shall be noted that the type, actual structure, implementation method, and/or connection method associated with the image capturing unit 201, the processing unit 203, the storage unit 205, and the communication unit 207 may depend on the actual implementation of the multimedia evaluation apparatus 20, and thus the instant embodiment is not limited thereto. Additionally, FIG. 3A to FIG. 3E are merely used for illustrating several types of facial expressions, and the present disclosure is not limited thereto. Similarly, FIG. 4 is merely served to provide a schematic diagram of an evaluation functionality configuration interface while FIG. 5 is merely served to provide an application of the emotional tags in a multimedia player with emotional tags, and the present disclosure is not limited thereto.

### Second Exemplary Embodiment

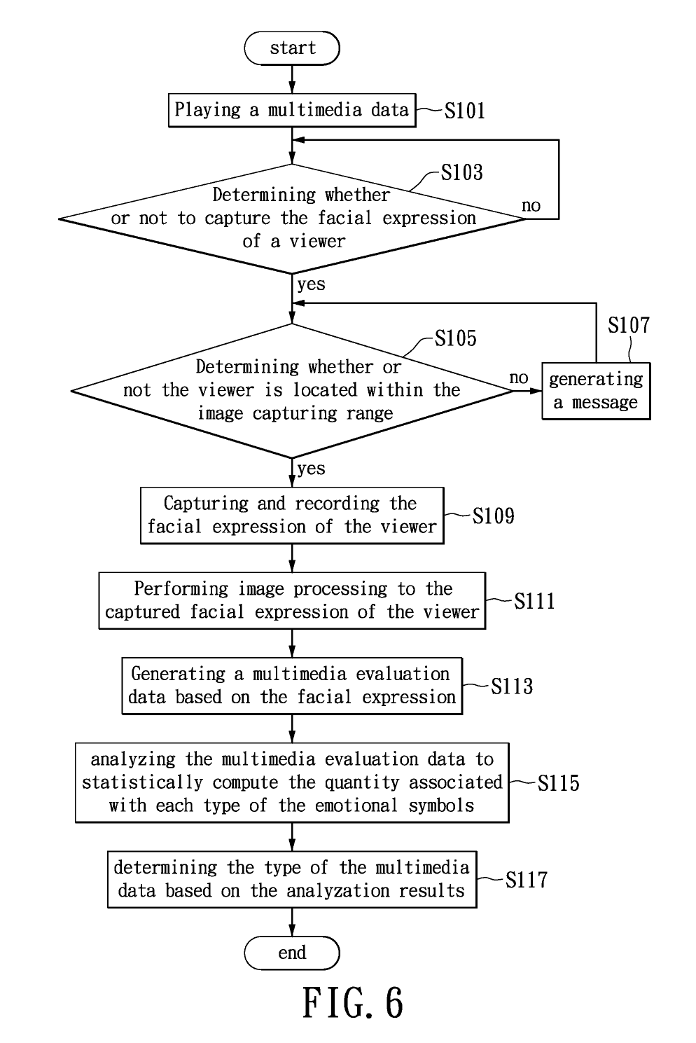

From the aforementioned exemplary embodiment, the present disclosure may generalize a multimedia evaluation method which can be adapted for applied to the mentioned multimedia system illustrated in the aforementioned embodiment. Please refer to FIG. 6 in conduction with FIG. 1 and FIG. 2. FIG. 6 shows a flowchart diagram illustrating a multimedia evaluation method provided in accordance to the second exemplary embodiment of the present disclosure.

In Step S101, a multimedia data is played on the display unit 10, wherein the multimedia data may be a video (e.g., a movie or a television program), an image (e.g., a photo or a presentation slide), or an article.

In Step S103, the processing unit 203 of the multimedia evaluation apparatus determines whether or not to capture the facial expression of the viewer. When the processing unit 203 determines to capture the facial expression of the viewer, executes Step S105, otherwise returns to Step S103. For instance, the processing unit 203 may provide the viewer with an evaluation functionality configuration interface 111 as shown in FIG. 4 on the display unit 10 so that the viewer can select whether or not to turn on the operation of capturing the facial expression of the viewer. The processing unit 203 then determines the operation accordingly.

In Step S105, the processing unit 203 determines whether or not the viewer is located within the image capturing rage, wherein the image capturing rage depends on the structure of the image capturing unit 201. When the processing unit 203 determines that the viewer is located outside the image capturing rage of the image capturing unit 201, executes Step S107. On the other hand, when the viewer is located within the image capturing rage of the image capturing unit 201 executes Step S109.

In Step S107, the processing unit 203 drives the display unit 10 to display a message informing the viewer and returns to Step S105. In Step S109, the processing unit 203 continuously or after every predetermined time interval drives the image capturing unit 201 capturing the facial expression of a viewer when viewing a multimedia data to have the image capturing unit 201 correspondingly outputs the images of the facial expression. The processing unit 203 stores the images of the facial expression outputted by the image capturing unit 201 in the storage unit 205. At the same time, the processing unit 203 records and stores the playback time in corresponding to the multimedia data in the storage unit 205.

In Step S111, the processing unit 203 performs image processing analysis and the facial feature extraction operation on the image of the facial expression. The processing unit 203 can then in Step S113 generate a multimedia evaluation data according to the images of facial expression. The multimedia evaluation data includes a plurality of emotional tags wherein each emotional tag has an emotional symbol and a playback time in corresponding to the multimedia data.

Subsequently, the processing unit 203 can determine the type of the multimedia data according to the multimedia evaluation data. In Step S115, the processing unit 203 analyzes the multimedia evaluation data and statistically computes the quantity associated with each type of the emotional tags. In Step S117, the processing unit 203 can determine the type of the multimedia data based on the analyzation results of each type of the emotional symbols.

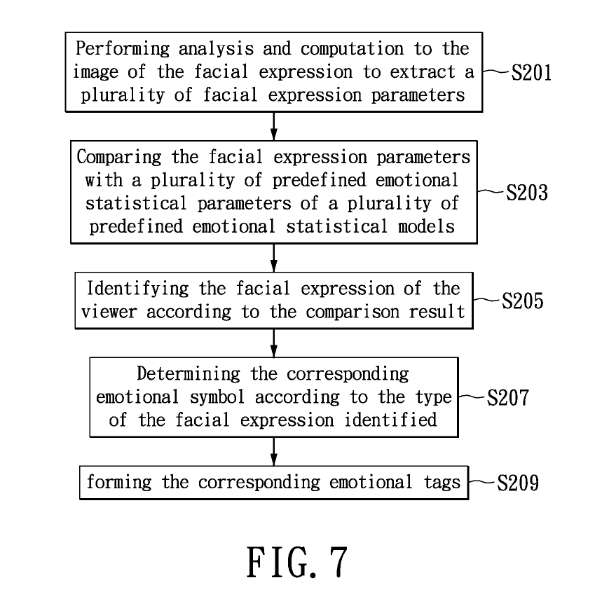

In addition, the method of facial expression analyzation method further includes the following steps. Please refer to FIG. 7 which shows a flowchart diagram illustrating a facial expression analyzation method provided in accordance to the second exemplary embodiment of the present disclosure.

In Step S201, the processing unit 203 may acquire a plurality of facial expression parameters of an image of the facial expression through utilizing the image processing method and the facial feature extraction operations described in the aforementioned embodiment. The facial expression parameters may include the relative location, distance, size, and shape associated with eye brows, eyes, a nose, a mouth, and a chin.

In Step S203, the processing unit 203 compares the facial expression parameters with a plurality of predefined emotional statistical parameters associated with a plurality of predefined emotional statistical models, wherein each predefined emotional statistical model corresponds to one type of facial expression. The facial expressions are respectively described by a plurality of predefined emotional statistical models. The plurality of predefined emotional statistical models may for instance include but not limited to a neutral emotional statistical model, a joy emotional statistical model, a disgust emotional statistical model, an anger emotional statistical model, and a surprise emotional statistical model. In Step S205, the processing unit 203 can identify and analyze the facial expression of viewers through comparing the extracted facial expression parameters with a plurality of predefined emotional statistical parameters associated with a plurality of predefined emotional statistical models.

In Step S207, the processing unit 203 determines the corresponding emotional symbol according to the identified type of the facial expression (For example, as shown in the FIG. 4, a happy emotional symbol 1151, a laughing emotional symbol 1152, an exciting symbol 1153, a sadness emotional symbol 1154, a touching emotional symbol 1155, and a disgust emotional symbol 1156). In Step S209, the processing unit 203 generates a corresponding emotional tag according to the selected emotional symbol and the playback time in corresponding to the multimedia data. The processing unit 203 can also store the emotional tags in the storage unit 205 for generating the multimedia evaluation data in corresponding to the multimedia data in the later steps.

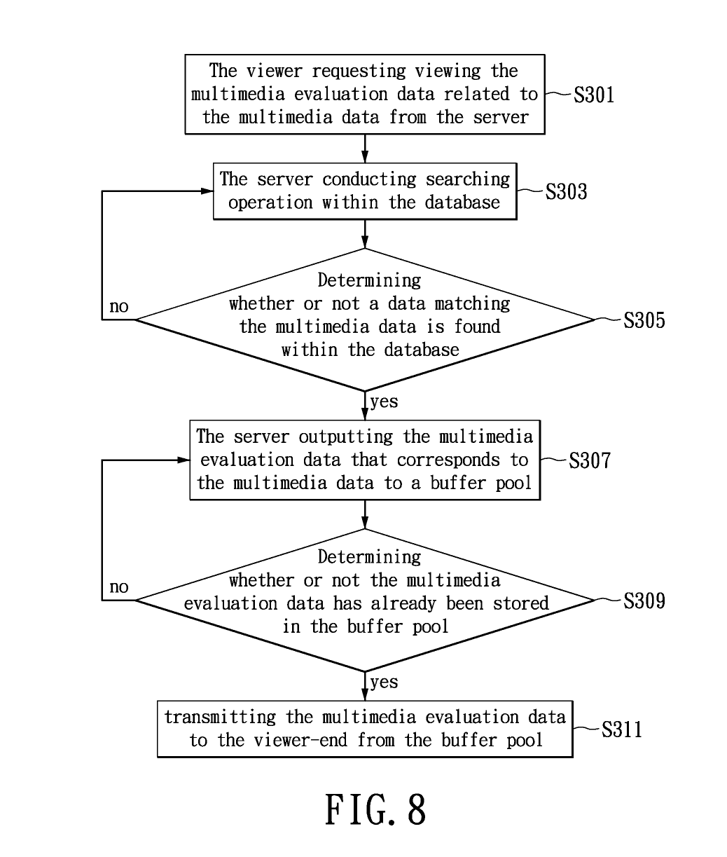

Moreover, supposing the multimedia data is provided on a video website and the data of the video website is stored in a server. The processing unit 203 can drive the communication unit 207 transmitting the captured images of facial expression to the server through the internet so as to have the server analyzing the facial expression and generating the multimedia evaluation data. The viewers can acquire the multimedia evaluation data using the method for acquiring the multimedia evaluation and the multimedia evaluation apparatus provided in the instant embodiment. Please refer to FIG. 8 in conjunction with FIG. 2. FIG. 8 shows a flowchart diagram illustrating a method for acquiring the multimedia evaluation data provided in accordance to the second exemplary embodiment of the present disclosure.

In Step S301, the viewer-end utilizes the communications unit 207 of the multimedia evaluation apparatus 20 transmitting a command requesting viewing the multimedia evaluation data related to the multimedia data to the server through the internet. In Step S303, the server conducts search operation for the multimedia data in a database thereof. In Step S305, the server determines whether or not a match has been found. When a match has been found, executes Step S307, otherwise executes Step S303 and continue with the searching operation.

In Step S307, the server outputs the multimedia evaluation data in corresponding to the multimedia data to a buffer pool. In Step S309, the server determines whether or not the buffer pool has the multimedia evaluation data stored therein. When the server determines that the multimedia evaluation data has been stored in the buffer pool, executes Step S311, otherwise returns to Step S307. In Step S311, the server transmits the multimedia evaluation data to the communication unit 207 of the multimedia evaluation apparatus 20 at the viewer-end from the buffer pool. Accordingly, the viewer can obtain the type and the content of the multimedia data reviewing the multimedia evaluation data on the display unit 10. Additionally, the viewer can configure the multimedia evaluation apparatus 20 to integrate the multimedia evaluation data into a multimedia player so that the viewer may view specific segment of the multimedia data through selecting emotional tags The viewer may further use the emotional tags in the multimedia evaluation data to search and select a desired multimedia data using the multimedia evaluation apparatus 20.

It is worth to note that in practice, the multimedia evaluation method provided in the instant embodiment may be applied in a multimedia playback software e.g., multimedia player. In particular, the installation sources may be installed in the multimedia player and the shortcuts may be configured therein. Such that, the viewer can run the above-mentioned multimedia playback software after the installation via the configured shortcuts to activate the multimedia evaluation operation. A window of evaluation functionality configuration interface 111 as shown in FIG. 4 can be called to activate the facial expression capture and analyzation processes, however, the present disclosure is not limited thereto.

In addition, the present disclosure may be implemented using a computer readable recording media wherein the computer readable recording media stores the computer program for executing the aforementioned multimedia evaluation method. The computer readable recording media may be a floppy disk, a hard disk, a compact disk (CD), a USB Disk, a magnetic tape, a Network to access the database, or other storage medium having the same function that those skilled in the art should be able to deduce.

It shall be noted that FIG. 6 and FIG. 7 are merely used to illustrate the multimedia evaluation method and the facial expression analyzing method provided in the instant embodiment of present disclosure, and the present disclosure is not limited thereto. Similarly, FIG. 8 is merely served to illustrate an actual operation of data transmission between the multimedia evaluation apparatus and the server, thus the present disclosure is not limited thereto.

In summary, the exemplary embodiments of present disclosure provide a multimedia evaluation system, an apparatus thereof, and a method using the same. The disclosed multimedia evaluation system, the apparatus thereof, and the method using the same can determine the type of a multimedia data through capturing and analyzing the facial expression of the viewer when viewing a multimedia data such as a video or a presentation slide. Thus, the disclosed multimedia evaluation system, the apparatus thereof, and the method using the same may precisely and effectively determine the type and the content of the multimedia data by the true feelings of the viewer instead of plain words and subjective comments. The degree of viewing interest of the viewers may thereby be increased.

The disclosed system, apparatus, and method for multimedia evaluation can divide the multimedia data into segments and then integrate the segmented multimedia data into a multimedia playing program such as a multimedia player for the viewer to select from. Additionally, after the disclosed system, apparatus, and method for multimedia evaluation defines the type of the multimedia data, the viewer can search and select the multimedia data to view via the emotional tags, thereby may increase the efficiency of viewing and commenting the multimedia data.

Moreover, the system, apparatus, and method for multimedia evaluation disclosed by the exemplary embodiments of the present disclosure provides the multimedia data provider the most direct way to evaluate the type and the content of the multimedia data. In addition, the idea of capturing and analyzing the facial expression of viewers to obtain the true feelings of the viewer toward the multimedia data can apply to other aspects such as market research for products, film production, and psychological assessment.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A multimedia evaluation system, comprising:
a display unit, for playing a multimedia data; and
a multimedia evaluation apparatus, coupled to the display unit, for capturing and recording the facial expression of a viewer when viewing the multimedia data to generate a multimedia evaluation data according to the facial expression of the viewer, wherein the multimedia evaluation data comprises of a plurality of emotional tags, each emotional tag having an emotional symbol and a playback time in corresponding to the multimedia data;
wherein the multimedia evaluation apparatus determines the type of the multimedia data according to the multimedia evaluation data.

2. The multimedia evaluation system according to claim 1, wherein the multimedia evaluation apparatus captures and records the facial expression of the viewer to generate the emotional tags after every predetermined time interval.

3. The multimedia evaluation system according to claim 1, wherein the types of the emotional symbol comprise of a happy emotional symbol, a joy emotional symbol, a sadness emotional symbol, an anger emotional symbol, a scaring emotional symbol, a disgust emotional symbol and a terrifying emotional symbol.

4. The multimedia evaluation system according to claim 1, wherein the multimedia data is provided on a video website for the viewer to view.

5. The multimedia evaluation system according to claim 1, wherein the multimedia evaluation apparatus divides the multimedia data into segments according to the emotional tags and integrates the segmented multimedia data into a multimedia player for the viewer to select.

6. The multimedia evaluation system according to claim 3, wherein the multimedia evaluation apparatus defines the type of the multimedia data based on the types and the quantities of the emotional symbols associated with the emotional tags.

7. The multimedia evaluation system according to claim 1, wherein the multimedia evaluation apparatus and the display unit are integrated in an electronic device.

8. A multimedia evaluation apparatus, comprising:
an image capturing unit, capturing and recording the facial expression of a viewer when viewing a multimedia data for correspondingly outputting an image of the facial expression;
a processing unit, coupled to the image capturing unit, receiving and analyzing the image of the facial expression to generate a corresponding multimedia evaluation data, wherein the multimedia evaluation data comprises an emotional symbol and a playback time in corresponding to the multimedia data; and
a storage unit, coupled to the processing unit, storing the image of the facial expression and the multimedia evaluation data;
wherein the processing unit determines the type of the multimedia data according to the multimedia evaluation data.

9. The multimedia evaluation apparatus according to claim 8, wherein the processing unit drives the image capturing unit capturing and recording the facial expression of the viewer to generate the emotional tags after every predetermined time interval.

10. The multimedia evaluation apparatus according to claim 8, wherein the processing unit determines the emotional symbol of the emotional tag through extracting a plurality of facial expression parameters in the image of the facial expression.

11. The multimedia evaluation apparatus according to claim 10, wherein the facial expression parameters comprise of the relative location, distance, size, and shape associated with eyebrows, eyes, a nose, a mouth, and a chin.

12. The multimedia evaluation apparatus according to claim 8, further comprising:
a communication unit, coupled to the processing unit, transmitting the multimedia data, the image of the facial expression and the multimedia evaluation data to a server through an internet.

13. The multimedia evaluation apparatus according to claim 8, wherein the image capturing unit is a webcam, a digital video camera, or a digital camera.

14. A multimedia evaluation method, applied to a multimedia evaluation apparatus, comprising:
playing a multimedia data;
capturing and recording the facial expression of a viewer viewing the multimedia data;
generating a multimedia evaluation data according to the facial expression of the viewer;
wherein the multimedia evaluation data comprises a plurality of emotional tags and each emotional tag has an emotional symbol and a playback time corresponding to the multimedia data; and
determining the type of the multimedia data according to the multimedia evaluation data.

15. The multimedia evaluation method according to claim 14, wherein the step of analyzing the facial expression comprises:
acquiring a plurality of facial expression parameters through analyzing the image of facial expression;
comparing the facial expression parameters with a plurality of predefined emotional statistical parameters associated with a plurality of predefined emotional statistical models, wherein each predefined emotional statistical model corresponds to a type of facial expression; and
determining the emotional symbol of the emotional tag according to the comparison result.

16. The multimedia evaluation method according to claim 15, wherein the step of determining the type of the multimedia data according to the multimedia evaluation data comprise:
analyzing the multimedia evaluation data and statistically computing the quantity associated with each type of the emotional symbols; and
determining the type of multimedia based on the analyzation and computation results associated with each type of the emotional symbols.

17. The multimedia evaluation method according to claim 16, wherein the step of building the statistical models comprises:
building a plurality of predefined emotional statistical models according to a plurality of emotional statistical parameters in corresponding to different facial expressions
wherein the predefined emotional statistical models comprise of a neutral emotional statistical model in corresponding to the neutral facial expression, a joy emotional statistical in corresponding to the joy facial expression, a disgust emotional statistical model in corresponding to the disgust facial expression, an anger emotional statistical model in corresponding to the anger facial expression, and a surprise emotional statistical model in corresponding to the surprise facial expression.

18. The multimedia evaluation method according to claim 17, wherein the facial expression parameters and the predefined emotional statistical parameters comprise of the relative location, distance, size, and shape associated with eyebrows, eyes, a nose, a mouth, and a chin.

19. The multimedia evaluation method according to claim 15, further comprising dividing the multimedia data into segments according to the emotional tags and integrating the segmented multimedia data into a multimedia player for the viewer to select.

20. The multimedia evaluation method according to claim 15, wherein the multimedia data is played through a video website with the emotional tags stored in the video website for the viewer to select to view the corresponding segment of the multimedia data.
